(19) United States
(12) Patent Application Publication
(10) Pub. No.: US 2007/0194899 A1
(43) Pub. Date: Aug. 23, 2007

(54) Indicator For A Control Wheel

(75) Inventor: Aharon Lipman, Michmoret (IL)

Correspondence Address: BRUCE E. LILLING;LILLING & LILLING PLLC, P.O. BOX 560, GOLDEN BRIDGE, NY, 10526, US

(73) Assignee: TENITEK LTD., Rosh HaAyin (IL)

(21) Appl. No.: 11/572,653

(22) PCT Filed: Jul. 26, 2005
(86) PCT No.: PCT/IL05/00798

§ 371 Date: Jan. 25, 2007

(30) Foreign Application Priority Data
Jul. 27, 2004 (IL) 163229

(51) Int. Cl. B60Q 1/00

(52) U.S. Cl. 340/456

(57) ABSTRACT

An indicator for indicating displacement of a controller displaceable about an axis angled to vertical direction: the indicator comprising an epicyclical gear comprising a sun gear, a planetary gear and an annular gear; the sun gear being coaxial with the annular gear; the annular gear being asymmetrically weighted to be self rightening by gravity; the sun gear being fixable to the controller and serving as a driving gear; the planetary gear being driven around the inside of the annular gear by the sun gear, wherein a centre of the planetary gear serves as a pointer and a reference indication is fixed to the annular gear such that relative position of pointer with respect to reference indication indicates displacement of the controller about its axis.

### FIELD OF THE INVENTION

The present invention is directed to providing an indicator for attachment to a control wheel, for giving a visible indication of the rotation of a controller around an axis angled to the vertical, and is further directed to providing a method of use for the indicator. Such an indicator has wide application. One application for such an indicator is to affix to a valve control wheel to indicate the degree to which a valve is opened or closed. Another application of particular interest is to affix the indicator to the steering wheel of a vehicle to indicate the angle through which the wheels of the vehicle are displaced.

### BACKGROUND OF THE INVENTION

There are a number of levellers that use a plumb bob or the like, to indicate the angle to which a body to which they are attached is displaced from the vertical. Surveying and building apparatus use such a principle.

Electrical knobs such as potentiometers that may be rotated by some angle of up to a full rotation often include a pointer that can be aligned with a scale to indicate the degree of rotation of the knob. Such a scale can be calibrated in different units and with different full-scale deflections, as appropriate. Such devices measure displacements of up to 360°, and are thus of no use for monitoring the number of times the control wheel of a stopcock or gate-valve is rotated, for example. If attached to the steering wheel of a vehicle, such devices can indicate that the wheel has been rotated, but if the rotation is a full 360° or more, they provide no indication of that fact. Essentially, such devices indicate small rotations, but do not count full turns, and are of no use to indicate rotations of more than 360°.

Furthermore, a counter that counts full turns has limited value. A worker at a chemical plant is not generally interested in seeing that a wheel operated gate-valve or stopcock has been turned 3, 4, or 5 times. Typically, such a worker will not even know how many times the wheel has been turned. What the worker requires is an indication that a valve is closed, partially open, or fully open.

Winches are typically rotated a number of times to raise or lower loads, and it may be necessary or desirable to indicate to the operator of such a winch as to whether the load is near the extreme raised or lowered position.

Different cars have different steering ratios, i.e. the ratio between a full turn of the steering wheel, and the average angle of turn provided to the two front wheels. Such steering ratios vary between vehicles, with a larger steering ratio providing a sportier driving experience. Furthermore, the number of turns of the steering wheel between the so-called “full-lock” at each turning extremity varies between vehicles, as does the maximum angle provided to the wheels. Generally the steering wheel of a car may be rotated 3 or 4 complete revolutions. Thus there are usually two and sometimes four displaced wheel orientations that all appear to the driver as if the steering wheel is in its neutral position, giving the illusion that the wheels lie aligned in their forward facing centered position. In regular driving, the driver knows which way the wheels are pointing. However, there are numerous scenarios where a driver may be confused as to the position of the wheels. When manoeuvring in a tight space, such as parking, particularly when reverse parking or backing into a parking space in a congested car park, or when backing out over an inspection pit, such information may be critical. Some drivers find difficulty in judging angles and distances. What frequently happens is that the driver having difficulty vacates the driving seat, often in mid-manoeuvre, and a passenger, car park attendant or bystander takes over and completes the parking manoeuvre. If the steering wheel is turned from the centred or “rest” position, there is a possibility of the car lurching forwards or backwards at an angle, and such an occurrence may result in an accident.

When driving on snow, in mud, on sand or other surface with low traction, it may be useful, if not essential, to know the position of a vehicle's wheels.

The problem of determining the orientation of a car's wheels from the steering wheel is a real one. Various solutions are described in the prior art.

For example, U.S. Pat. No. 5,610,577 to Hwang describes an automobile front-wheel orientation and turning-angle indicator that is arranged at the centre of the steering wheel to indicate the orientation and turning-angle of the front-wheels. The indicator comprises a rotating disk, a scale disk, an indicator disk, and a housing, wherein the scale disk has a dead weight to maintain a constant orientation at all times. A rotating disk is located at the lower part of the whole indicator and is mounted on the steering wheel. The indicator is driven by the rotating disk through transmission means, so as to produce a rotation relative to the scale disk, and to achieve the purpose of indicating orientation and turning-angle of the front-wheel. One disadvantage of Hwang's solution is that it is necessary to connect the lower rotating disk to the centre of the steering wheel (see Column 3 lines 23 to 25 thereof). Another disadvantage is that the housing moves relative to the steering wheel, rather than together with the steering wheel. This relative movement means that the housing cannot be fully sealed and is thus susceptible to the accumulation of dirt and grime on the mechanism, which can prevent the functioning thereof. To move the indicator with respect to the casing, rotating the indicator in the right direction, a pair of transmission gears is required. Each gear rotates around its axle and there are thus three gears that rotate around axles generating a sizeable amount of friction, which adversely affects reliability of the system. The weight of the indicator is carried on the main axle and, due to the transmission gears, is not evenly distributed. In consequence, the axle is susceptible to bending. Due to the large number of parts, the Hwang's indicator is also expensive to manufacture. For these among other reasons, the indicator described to Hwang is generally unreliable.

United Kingdom Patent Number GB 2,350,680 to Wang describes another position indicator for a steering wheel that indicates the position of the wheels of a car. In the Wang patent, a ‘sign’, i.e. a pointer, is kept in a vertical direction by a weight, and an indication plate, shaped like a car, is ‘deviated’, that is, tilted with respect to the sign, by a gear mechanism, to indicate the angular offset. In the Wang patent, the tilt of the car wheels is indicated visually, qualitatively, but there is no scale provided and it is thus not indicated quantitatively. Once again, a pair of transmission gears is required to produce rotation of the indication plate in the right direction, and the combined friction of the various bearings is considerable. For these and other reasons, the object of the invention is described as serving ‘to present a cute and lively modelling for decoration’, and does not give an accurate indication of the orientation of the car's wheels.

Korean laid open patent no. 10-2002-0026017 describes a wheel angle indicator that is apparently built into a car and not easily retrofitted thereto, and which indicates that wheels are pointed to the left or right, but gives no clear and easily comprehendible indication of the steering angle.

None of the above referenced publications provides a calibrated, unambiguous and reliable indication of the steering wheel angle. Furthermore, none of the above referenced publications is adaptable to other types of control wheels such as winches or valve wheels.

There are thus a number of scenarios where it is useful for an operator of a control wheel that is rotatably displaceable between limits that are separated by more than a full rotation, to be able to visually determine the degree of rotation of the wheel from a reference position. The present invention provides a utility device and corresponding method for making such a determination.

### SUMMARY OF THE INVENTION

It is an object of embodiments of the invention to provide an indicator that indicates the angle of rotation of a controller that may be calibrated in terms of a controlled parameter.

It is another object of the invention to provide an indicator that is easily retrofittable to controllers, such as steering wheels.

It is yet another object of the invention to provide an indicator having a minimum number of parts, both to minimize manufacturing costs and to reduce friction.

In a first aspect, the present invention is directed to providing an indicator for indicating displacement of a controller displaceable about an axis angled to vertical direction: said indicator comprising an epicyclical gear mechanism comprising a sun gear, a planetary gear and an annular gear; the sun gear being coaxial with the annular gear; the annular gear being asymmetrically weighted to be self-rightening by gravity; the sun gear being fixable to the controller and serving as a driving gear; the planetary gear being driven around the inside of the annular gear by the rotating sun gear, wherein the center of the planetary gear serves as a pointer and a reference indication is fixed to the gravity stabilized annular gear such that relative position of the pointer with respect to the reference indication indicates displacement of the controller about its axis.

Typically the annular gear is asymmetrically weighted by having a weight attached thereto at an off-centre location.

Typically the indicator is encased in a case having a back and a front; the back of the case for fixing to the controller, the front of the case including a transparent window for viewing the pointer therethrough; the sun gear being fixedly coupled to the case and having an axial mount centred on the axis of the sun gear for mounting the annular gear thereupon.

The indicator may be integral to the controller or may be retrofittable thereto by an adhesive for sticking the indicator to the controller or by a mechanical fixing means selected from the list of rivets, screws, bolts, pins and nails, for example.

Typically, the indicator further comprises a scale and the pointer is displaceable along the scale by driven movement of the planetary gear around the annular gear by driving rotation of the sun gear corresponding to rotation of the indicator by displacement of the controller about its axis.

Optionally the controller controls a variable parameter and the scale is calibrated in accordance with the variable parameter.

Optionally the controller is a control wheel.

Typically the controller selected from the list of steering wheels for vehicles, winches, control wheels for valves and control wheels for electrical equipment.

Optionally the controller is displaceable between limits separated by more than one complete revolution and position of the pointer relative to the reference indication indicates total displacement of the controller about the axis.

Preferably the pointer is a spot marked on centre of planetary gear.

Most preferably, the spot is highly visual by virtue of being illuminated, reflective, fluorescent or phosphorescent, for example.

Preferably the reference indication is highly visual by virtue of being illuminated, reflective, fluorescent or phosphorescent, for example.

Optionally the planetary gear is transparent and moves between the annular gear and the front panel of the case, the front panel of the case has a transparent window thereon and the indicator scale is marked on the annular gear and is viewed through said window and through the planetary gear.

Alternatively, the planetary gear is opaque, the annular gear is transparent and the front panel of the case has a transparent window thereon and the indicator scale is marked on the annular gear and the planetary gear is viewed through said window and through the annular gear.

Optionally a logo is attached to the front panel of the case over the sun gear for advertising purposes.

In one embodiment the controller is a control wheel that controls a variable parameter; the control wheel being displaceable between limits separated by more than one complete revolution; the reference indication being part of a scale calibrated in terms of the controlled variable parameter and the pointer for moving along the scale in response to movement of the sun gear with respect to the annular gear to indicate variation of the controlled parameter.

In a preferred embodiment the controller is a steering wheel of a vehicle and the relative position of the pointer with respect to the scale corresponds to rotation of the steering wheel and provides an indication of the direction of the front wheels of the vehicle with respect to the chassis of the vehicle.

In a second aspect, the present invention relates to a method of monitoring the position of front wheels of a vehicle with respect to chassis of said vehicle comprising the steps of: (a) fixing an indicator to steering wheel of said vehicle, the indicator comprising a case encasing an epicyclical gear comprising a sun gear, a planetary gear and an annular gear; the sun gear being coaxial with the annular gear; the annular gear being asymmetrically weighted to be self-rightening by gravity; the sun gear being fixed to the case and being fixable to the steering wheel and serving as a driving gear; the planetary gear being driven around the inside of the annular gear by the sun gear, wherein centre of the planetary gear serves as a pointer and a reference indication is fixed to the annular gear such that relative position of the pointer with respect to the reference indication indicates displacement of the steering wheel about its axis, the reference indication being a centre mark on a scale calibrated in terms of the position of the front wheels of the vehicle with respect to the chassis, and (b) observing the relative position of the pointer with respect to the scale.

In a third aspect, the present invention is directed to providing an eccentrically weighted annular gear comprising a disc having an annular ring attached to perimeter thereof and a bearing around the center of the disk for mounting onto an axle pin therethrough, the disk further comprising a weight for providing the eccentric weighting.

Preferably, the eccentrically weighted annular gear is injection molded from polycarbonate, the bearing is an insert of alpha brass and the weight is an iron insert, the polycarbonate being injection molded about the inserts.

Most preferably, the polycarbonate including glass fibers as a filler to minimize shrinkage of the eccentrically weighted annular gear when removing from its mold.

### BRIEF DESCRIPTION OF THE DRAWINGS

For a better understanding of the invention and to show how it may be carried into effect, reference will now be made, purely by way of example, to the accompanying drawings.

In the accompanying drawings:

FIG. 1 is a schematic sketch of the controls of a car showing an indicator of the invention attached to the steering wheel thereof;

FIG. 2 is a schematic cut away view of one embodiment of the indicator of the present invention;

FIG. 3 is an exploded cross-section view of one embodiment of the indicator of FIG. 2;

FIG. 4 is a cross-section of the indicator of FIG. 3 as assembled;

FIG. 5 is an exploded isometric projection of the indicator of FIG. 3;

FIG. 6 is a cross-section of a second embodiment of the indicator of FIG. 2, and

FIGS. 7a and 7b show the path of the planetary gear around the inside of the annular gear in response to the rotation of the sun gear.

### DETAILED DESCRIPTION OF THE EMBODIMENTS

With specific reference now to the Figures in detail, it is stressed that the particulars shown are by way of example and for purposes of illustrative discussion of preferred embodiments of the present invention only, and are presented in the cause of providing what is believed to be the most useful and readily understood description of the principles and conceptual aspects of the invention. In this regard, no attempt is made to show structural details in more detail than is necessary for a fundamental understanding of the invention.

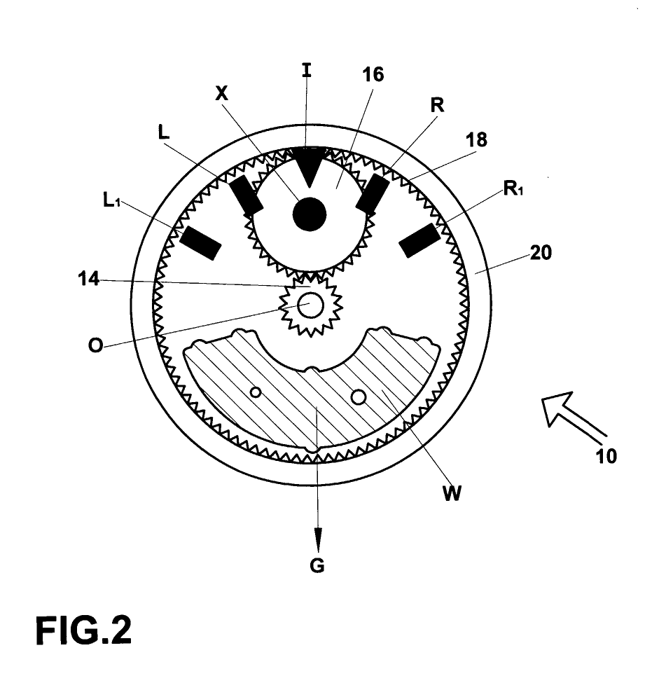

The description taken with the Figures will make apparent to those skilled in the art how the invention may be embodied in practice. One preferred embodiment is shown in FIGS. 2, 3 and 4; it being noted that similar parts are annotated with similar notations throughout.

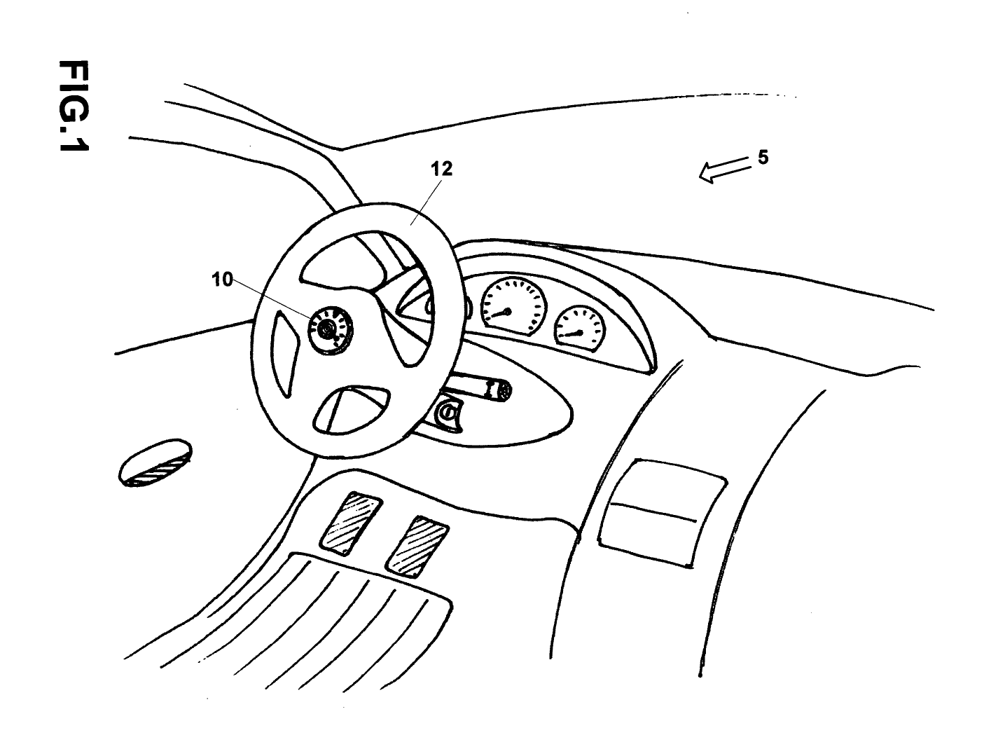

Referring now to FIG. 1, an indicator 10 coupled to a steering wheel 12 of a vehicle 5 is shown. The indicator 10 indicates the displacement of the steering wheel 12 about its axis, and, by being calibrated in terms of the position of the front wheels of the vehicle 5 with respect to the chassis, provides an indication of the position of the front wheels, and thus indicates to the driver whether the steering wheel 12 has been rotated through more than 360°, it being appreciated that fully rotating the steering wheel 12 to the left or right brings it back to the same position, and thus without such an indicator, the driver cannot know the position of the wheels unambiguously, which can cause accidents when starting up the vehicle, during parking or when off-road rallying or driving cross-country, for example.

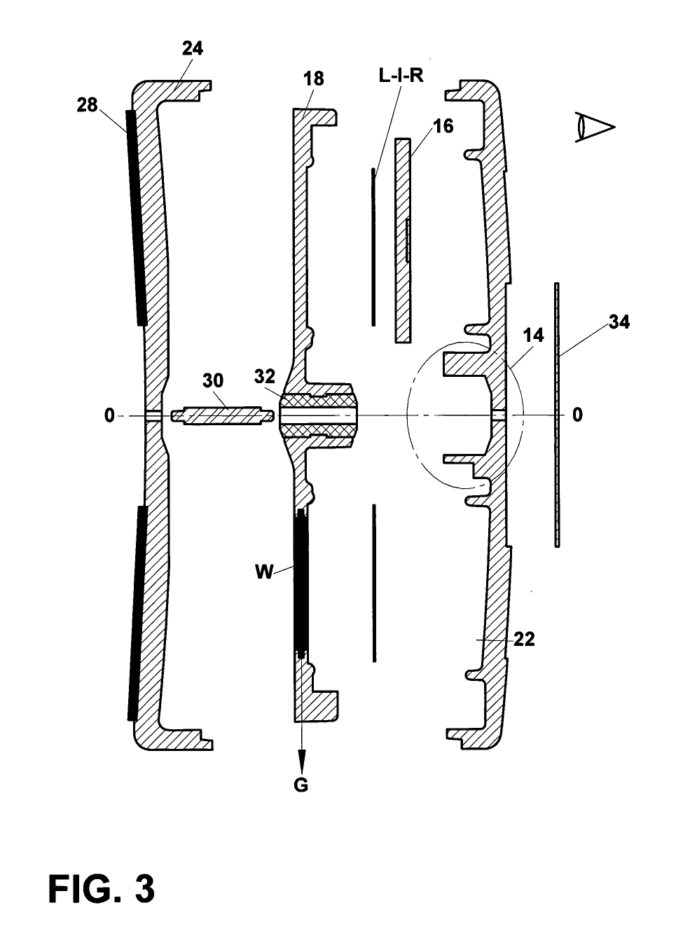

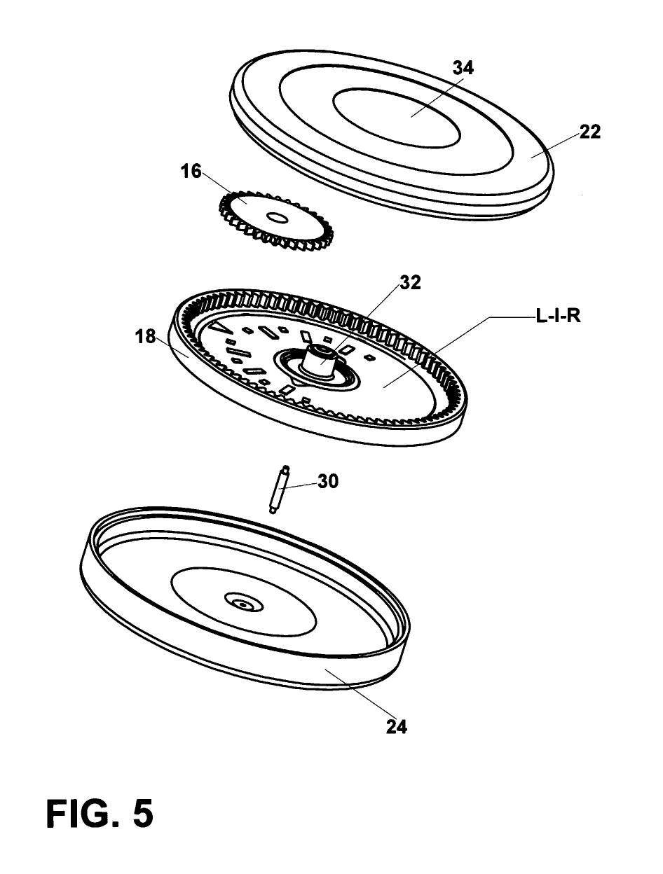

Referring to FIG. 2, the indicator 10 is constructed about a standard epicyclical gear constructed from a sun gear 14, a planetary gear 16 and a ring gear or annular gear 18. The sun gear 14 is coaxial with the annular gear 18 and the epicyclical gear is encased within a case 20. As with all epicyclical gear systems, one gear is stationary, one gear serves as a driver gear and one gear serves as the driven gear. Referring to FIGS. 3, 4 and 5, in the present invention the sun gear 14 is fixedly attached to the case 20 which has a front panel 22 and a back panel 24 and may be attached to a controller such as the steering wheel 12 (FIG. 1) of a car. The indicator 10 rotates with the controller, and the sun gear 14 drives the planetary gear 16 around the inside of the annular gear 18 which is asymmetrically weighted by a weight W and is free to rotate about its axis O so that its centre of gravity stays as low as possible, thus annular gear 18 is self-rightening. The planetary gear 16 is driven around the inside of the annular gear 18 by rotation of the sun gear 14 together with the case 20 and the steering wheel 12 (FIG. 1) or other controller to which it is coupled. The planetary gear 16 moves with respect to the annular gear 18 and the case 20, as it is driven by sun gear 14 around the inside of the annular gear 18. A reference indication I is fixed to the annular gear 18 which corresponds to the rest position of the steering wheel and thus to the forwards pointing position of the front wheels of the vehicle. The position of the centre of the planetary gear 16 serves as a pointer X, and its relative position with respect to the reference indication I indicates whether the steering wheel 12 is turned towards the left L or towards the right R, and, since the steering wheel 12 is coupled to the wheels of the vehicle, the displacement of the centre X of the planetary wheel 16 with respect to the reference indication I indicates whether the wheels of the vehicle are turned to the left L or the right R.

If a scale is provided, such as tick marks L₁, R₁ to the left and right of the central reference mark I, the degree with which the steering wheel 12 is rotated can be gauged. The outermost marks L₁, R₁ may be positioned to correspond to full-lock for example, where the steering wheel 12 and the front wheels of the vehicle are positioned in their most extreme deviations from the rest position defining the minimum turning circle.

As long as the annular gear 18 is asymmetrically weighted by having a weight W attached thereto at an off-centre location and the axle 0 thereof is angled to the vertical direction, the indicator 10 will work to show the direction in which the wheels of the vehicle are turned, and the amount of turn. The indicator scale L-I-R may be calibrated in terms of turns of the steering wheel 12 (FIG. 1), or, perhaps more usefully, in terms of the angle of the front wheels of the vehicle with respect to the forward pointing direction, i.e. the angle between the wheels and the chassis.

The gear ratio between the annular gear 18 and sun gear 14 determines the amount of offset resulting from one full rotation of the steering wheel 12, and for a given casing size, the relative sizes of the sun gear 14, planetary gear 16 and annular gear 18 can be varied. In this manner, the indicator 10 of the invention may be optimized and calibrated for specific vehicles with specific turning circles and varying numbers of turns of the steering wheel 12 between full-lock to the left and full-lock to the right; it being noted that the steering ratio and turning circle varies between different vehicles.

The indicator 10 of the invention may be integral to the steering wheel 12 and supplied with the vehicle by the manufacturer. It is a particular feature of the invention that the indicator may easily be retrofitted to the steering wheel of an existing vehicle by a fixing means 28, possibly being simply stuck thereto with an appropriate adhesive or fixed thereto with some mechanical fixing means such as with rivets, screws, bolts, pins or nails. Furthermore, provided that the case 20 of the indicator 10 rotates with the steering wheel 12, the indicator 10 will work adequately, and there is no need for the indicator 10 to be positioned centrally and coaxially with the steering wheel 12.

The indicator 10 is usually encased within a case 20 having a back 24 that is attached to the steering wheel 12 by the fixing means 28, and a front 22 that is transparent or at least includes a transparent window for allowing viewing of the pointer X therethrough. Typically the case 20 will include an axial mount 30 centred on the axis 0 of the sun gear 14 for mounting the annular gear 18 thereupon. Usefully bearing 32 fabricated from a low friction material such as brass is provided.

Since the epicyclical gear system of the indicator 10 has to drive the planetary gear 16 only, and is not coupled to an external load, the teeth of the gears may be simple, straight cut, intermeshing teeth. The sun gear 14 and case 20, the planetary gear 16 and the annular gear 18 are preferably injection moulded from a plastic, preferably polycarbonate. Apart from pointer X, which is, by necessity opaque and preferably highly visual, the planetary gear 16 is preferably transparent, so that indicator scale L-I-R, which may be a label stuck onto the annular gear 18, is observable therethrough.

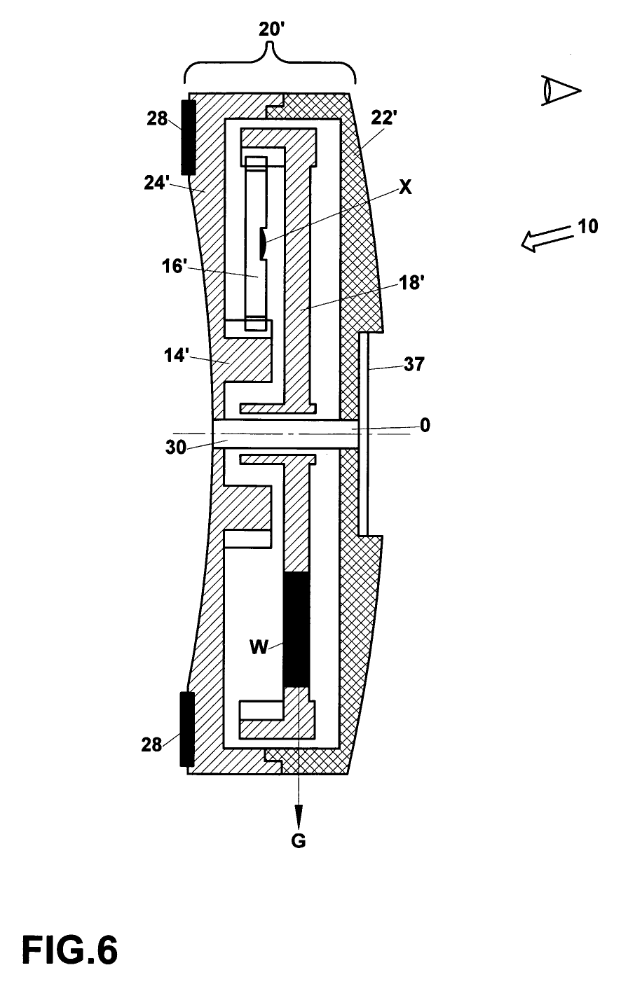

Referring to FIG. 6, in a second embodiment the annular gear 18′ is fabricated from a transparent plastic such as polycarbonate, and the planetary gear 16′ is positioned therebehind. The indicator scale L-I-R is attached to the front of the annular gear 18 and the planetary gear 16 is viewed through the annular gear 18′. Here the sun gear 14 may be attached to the back 24′ of the case 20′.

A label 34 carrying an image, such as a car logo, may be attached in the middle of the front panel 22 of the case 20 in front of the sun gear 14, for advertising purposes, for example.

The sun gear 14 is typically constructed together with the back 24 or front 22 of the case 20 in one piece. By varying the annular gear to sun gear ratio 18:14, the indicator 10 may be calibrated for different purposes, without altering the indicator scale L-I-R on the annular gear 18. Alternatively, the indicator scale L-I-R may be varied for a set annular gear to sun gear ratio 18:14. In both cases, the pointer X moves along the scale L-I-R being moved there-along by rotation of the planetary gear 16 around the annular gear 18 by driving rotation of the sun gear 14.

The indicator 10 of the invention is described hereinabove as applied to a steering wheel 12, the indicator scale L-I-R being calibrated either in terms of the number of rotations of the steering wheel or in terms of the actual angle of the front wheels. It will be appreciated however, that the indicator may be applied to other controllers for monitoring other controlled parameters. For example, the indicator 10 may be coupled to a winch or to the control wheel of a gate valve, or even to the controller of some electrical equipment where the controller moves in an arc about some axis. The scale need not be symmetrical about a reference point and may be calibrated from CLOSED to OPEN or from OFF to ON as appropriate, depending on the variable parameter of interest. The scale may read any appropriate units and depending on the gear ratio between the varying parameter and the controller and the gear ratio between the annular gear and the sun gear 18:14, the full-scale deflection may be set as appropriate.

All the components of the indicator may be fabricated by injection molding. The eccentrically weighted annular gear may be injection molded from polycarbonate, the resin being injected around the bearing 32, which is typically an insert of alpha brass, and the weight W, which may be an iron insert.

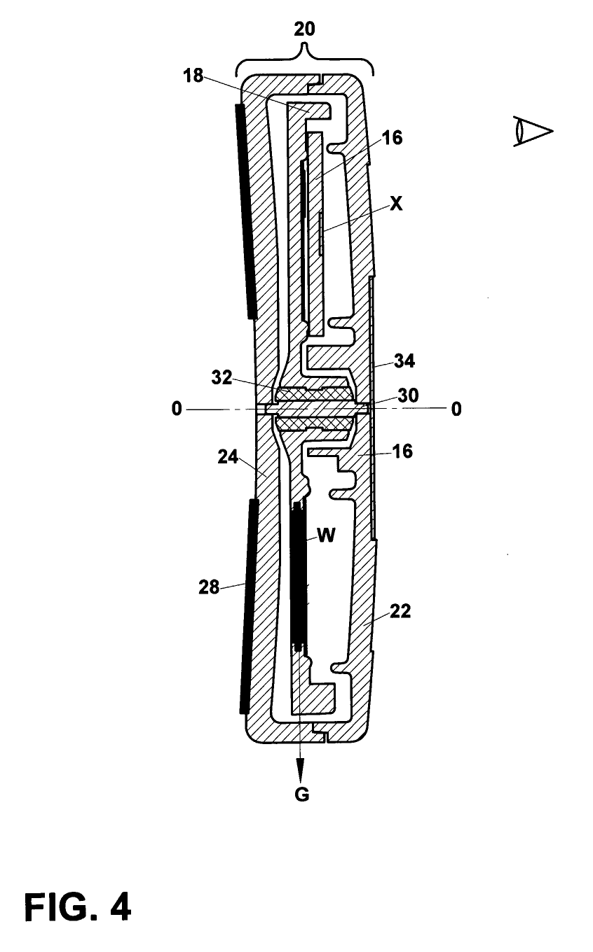

In the embodiment of FIGS. 3 and 4, where the eccentrically weighted annular gear 18 is not required to be transparent, the polycarbonate resin preferably includes glass fibers as filler, thereby minimizing shrinkage of the eccentrically weighted annular gear when removing from its mold. The axle pin 30 is typically steel and the bearing 32 is typically alpha brass. This materials combination provides tolerances of several microns and ensures smooth operation, even where the indicator 10 is attached to a steering wheel 12 tilted at only a slight angle to the horizontal.

It is a particular feature of the indicator of the present invention, that there is only one axle and the planetary gear, which is very light, is coupled to no external load and is driven directly by the driving gear. This arrangement results in low friction and high reliability, and enables the indicator to function correctly when tilted at only very shallow angles.

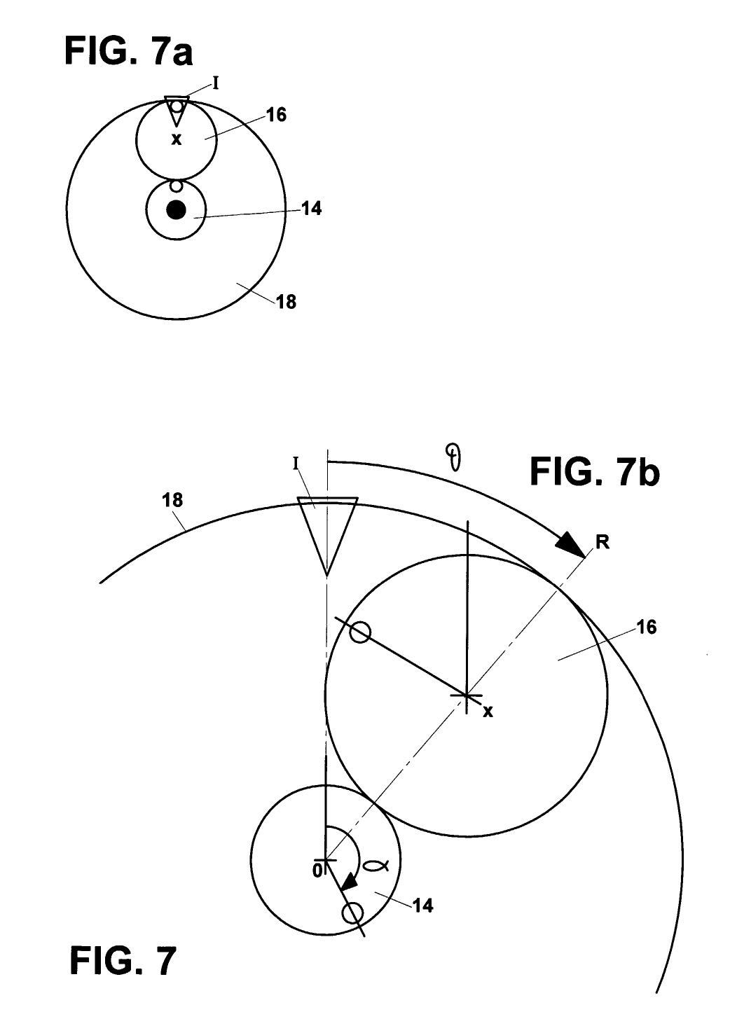

With reference to FIGS. 7a and 7b, the position of the planetary gear 16 with respect to the annular gear 18 is shown in two positions, a rest position (FIG. 7a) and an offset position (FIG. 7b), where the angle θ through which the planetary gear 16 moves, i.e. the offset of the pointer X is related to the rotation a of the sun gear 14 which directly corresponds to the rotation of the controller to which it is mounted (e.g. steering wheel) via the rotation of the case 20 by the equation:
θ/α=1(N₁₈/N₁₄+1)
where N₁₈ is the number of teeth on the annular gear 18 and N₁₄ is the number of teeth on the sun gear 14.

Unlike indicator marks fixed to control knobs, the indicator 10 of the present invention may be applied to controllers that are rotated by more than one complete revolution and still provide unambiguous indication of the number of rotations. Shut off valves for fluids at high pressure typically require rotating a number of times to fully close. Hitherto, it has been difficult and costly to provide a remote indication of whether such valves are open or closed. Provided the valve stem of such a valve is not fully vertical, an indicator of the invention provides such an indication, and may also provide indication of intermediate positions, corresponding to partially open or partially closed. Nevertheless, the indicator of the invention may be applied to controllers that move along a path of less than one full rotation.

Particularly however, the indicator 10 as described hereinabove provides a method of monitoring the position of front wheels of a vehicle with respect to the chassis of the vehicle by fixing such an indicator 10 to the steering wheel 12 of the vehicle and observing the relative position of the pointer X with respect to the reference indication I.

The pointer X is usually simply a spot marked on the centre of planetary gear 16. Preferably the spot is highly visual by virtue of being illuminated or painted with some pigment that is reflective, fluorescent or phosphorescent, for example.

Likewise the reference indication I, and scale L-I-R where provided, is preferably highly visual by virtue of being illuminated, reflective, fluorescent or phosphorescent or any other appropriate technique. In the embodiment of FIG. 6, where the pointer X and planetary gear 16′ are behind the transparent annular gear 18′, the reference indication I and scale L-I-R may be engraved or painted directly onto the transparent annular gear 18′ or may be printed onto a transparent label attached to the annular gear 18′.

Persons skilled in the art will appreciate that the present invention is not limited to what has been particularly shown and described hereinabove. Rather the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. An indicator for indicating displacement of a controller displaceable about an axis angled to vertical direction:
Said indicator comprising an epicyclical gear comprising a sun gear, a planetary gear and an annular gear;
The sun gear being coaxial with the annular gear;
The annular gear being asymmetrically weighted to be self-rightening by gravity;
The sun gear being fixable to the controller and serving as a driving gear;
The planetary gear being driven around the annular gear by the sun gear, wherein a centre of the planetary gear serves as a pointer and a reference indication is fixed to the annular gear such that relative position of pointer with respect to reference indication indicates displacement of the controller about its axis.

2. The indicator of claim 1 said annular gear being asymmetrically weighted by having a weight attached thereto at an off-centre location.

3. The indicator of claim 1 being encased in a case having a back and a front;
the back of the case for fixing to the controller, the front of the case including a transparent window for viewing the pointer therethrough;
The case having an axial mount for fixedly mounting the sun gear thereupon and including an axle for mounting the annular gear thereupon allowing free rotation of annular gear around the axle.

4. The indicator of claim 1 being integral to the controller.

5. The indicator of claim 1 being retrofittable to the controller.

6. The indicator of claim 5 further comprising an adhesive for adhering to the controller.

7. The indicator of claim 5 being attachable to the controller by a mechanical fixing means selected from the list of rivets, screws, bolts, pins and nails.

8. The indicator of claim 1 further comprising a scale and said pointer being displaceable along the scale by driven rotation of the planetary gear around the annular gear by driving rotation of the sun gear corresponding to rotation of the indicator by displacement of the controller about its axis.

9. The indicator of claim 8 wherein the controller controls a variable parameter and the scale is calibrated in accordance with the variable parameter.

10. The indicator of claim 1, the controller being a control wheel.

11. The indicator of claim 1 being a controller selected from the list of steering wheels for vehicles, ship's wheels, winches, control wheels for valves and control wheels for electrical equipment.

12. The indicator of claim 1 where said controller is displaceable between limits separated by more than one complete revolution and position of the pointer relative to the reference indication indicates total displacement of the controller about the axis.

13. The indicator of claim 1 wherein said pointer is a spot marked on centre of planetary gear.

14. The indicator of claim 13 wherein said spot is highly visual by virtue of being illuminated, reflective, fluorescent or phosphorescent.

15. The indicator of claim 1 wherein said reference indication is highly visual by virtue of being illuminated, reflective, fluorescent or phosphorescent.

16. The indicator of claim 1 wherein the planetary gear is transparent and moves between the annular gear and the front panel of the case, the front panel of the case having a transparent window thereon and the indicator scale being marked on the annular gear and being viewable through said window and through the planetary gear.

17. The indicator of claim 1 wherein the planetary gear is opaque, the annular gear is transparent and the front panel of the case has a transparent window thereon and the indicator scale is marked on the annular gear and the planetary gear is viewable through the window and through the annular gear.

18. The indicator of claim 1 having a logo attached to the front panel of the case over the sun gear for advertising purposes.

19. The indicator of claim 1 wherein said controller is a control wheel that controls a variable parameter;
Said control wheel being displaceable between limits separated by more than one complete revolution;
Said reference indication being part of a scale calibrated in terms of the controlled variable parameter and said pointer for moving along the scale in response to movement of the sun gear with respect to the annular gear to indicate variation in controlled parameter.

20. The indicator of claim 19 wherein said controller is a steering wheel of a vehicle and said relative position of the pointer with respect to the scale corresponds to rotation of the steering wheel and provides an indication of direction of front wheels of the vehicle with respect to chassis of the vehicle.

21. The indicator of claim 1, said planetary gear being transparent and said case having a transparent window on front panel thereof.

22. A method of monitoring the position of front wheels of a vehicle with respect to chassis of said vehicle by fixing an indicator of claim 1 to steering wheel of said vehicle and observing the relative position of the pointer with respect to the reference indication.

23. An eccentrically weighted annular gear comprising a disc having an annular ring attached to perimeter thereof and a bearing around the center of the disk for mounting onto an axle pin there through, the disk further comprising a weight for providing the eccentric weighting.

24. The eccentrically weighted annular gear of claim 23 being injection molded from polycarbonate, the bearing being an insert of alpha brass and the weight being an iron insert, the polycarbonate being injection molded about the inserts.

25. The eccentrically weighted annular gear of claim 23 the polycarbonate including glass fibers as a filler to minimize shrinkage of the eccentrically weighted annular gear when removing from its mold.
